(19) United States
(12) Patent Application Publication
(10) Pub. No.: US 2015/0224464 A1
(43) Pub. Date: Aug. 13, 2015

(54) RADIAL FLOW REACTOR HAVING A SIDE INLET NOZZLE AND METHODS FOR REACTING HYDROCARBONS USING THE SAME

(71) Applicant: UOP LLC, Des Plaines, IL (US)

(72) Inventors: Jeffrey Grott, Chicago, IL (US); Steven M. Poklop, Palatine, IL (US); Hadjira Iddir, Hoffman Estates, IL (US); David A. Wegerer, Lisle, IL (US)

(73) Assignee: UOP LLC, Des Plaines, IL (US)

(21) Appl. No.: 14/180,078

(22) Filed: Feb. 13, 2014

(51) Int. Cl. B01J 8/08

(52) U.S. Cl. CPC B01J 8/08

(57) ABSTRACT

A system for radial flow contact of a reactant stream with catalyst particles includes a reactor vessel and a catalyst retainer disposed in the reactor vessel, the catalyst retainer including an inner particle retention device and an outer particle retention device, the inner particle retention device and the outer particle retention device being spaced apart to define a catalyst retaining space of the catalyst retainer, the inner particle retention device defining an axial flow path of the reactor vessel, the outer particle retention device and an inner surface of a wall of the reactor vessel defining an annular flow path of the reactor vessel. The system further includes an inlet nozzle positioned along a side of the reactor vessel and having an exit opening in fluid communication with the annular flow path of the vessel and an outlet nozzle in fluid communication with the axial flow path.

### TECHNICAL FIELD

The present disclosure relates generally to the contacting of fluids and particulate materials. More specifically, this disclosure relates to the design and use of side-inlet radial flow reactors and regenerators.

### BACKGROUND

A wide variety of industrial applications involve radial or horizontal flow apparatuses for contacting a fluid with a solid particulate. Representative processes include those used in the refining and petrochemical industries for hydrocarbon conversion, adsorption, and exhaust gas treatment. In reacting a hydrocarbon stream in a radial flow reactor, for example, the feed to be converted is normally at least partially vaporized when it is passed into a solid particulate catalyst bed to bring about the desired reaction. Over time, the catalyst gradually loses its activity, or becomes spent, due to the formation of coke deposits on the catalyst surface resulting from non-selective reactions and contaminants in the feed.

Moving bed reactor systems have therefore been developed for continuously or semi-continuously withdrawing the spent catalyst from the catalyst retention or contacting zone within the reactor and replacing it with fresh catalyst to maintain a required degree of overall catalyst activity. Typical examples are described in U.S. Pat. No. 3,647,680, U.S. Pat. No. 3,692,496, and U.S. Pat. No. 3,706,536. In addition, U.S. Pat. No. 3,978,150 describes a process in which particles of catalyst for the dehydrogenation of paraffins are moved continuously as a vertical column under gravity flow through one or more reactors having a horizontal flow of reactants. Another hydrocarbon conversion process using a radial flow reactor to contact an at least partially vaporized hydrocarbon reactant stream with a bed of solid catalyst particles is the reforming of naphtha boiling hydrocarbons to produce high octane gasoline. The process typically uses one or more reaction zones with catalyst particles entering the top of a first reactor, moving downwardly as a compact column under gravity flow, and being transported out of the first reactor. In many cases, a second reactor is located either underneath or next to the first reactor, such that catalyst particles move through the second reactor by gravity in the same manner. The catalyst particles may pass through additional reaction zones, normally serially, before being transported to a vessel for regeneration of the catalyst particles by the combustion of coke and other hydrocarbonaceous by-products that have accumulated on the catalyst particle surfaces during reaction.

The reactants in radial flow hydrocarbon conversion processes pass through each reaction zone, containing catalyst, in a substantially horizontal direction in the case of a vertically oriented cylindrical reactor. Often, the catalyst is retained in the annular zone within a particle retention device. The device forms a flow path for the catalyst particles moving gradually downward via gravity, until they become spent and must be removed for regeneration. The device also provides a way to distribute gas or liquid feeds to the catalyst bed and collect products at a common effluent collection zone. In the case of radial fluid flow toward the center of the reactor, for example, this collection zone may be a central, cylindrical space within the particle retention device.

Radial flow reactor design typically requires that the volume upstream of the catalyst bed be minimized along with the reactor and piping pressure drop. Minimizing the volume upstream of the catalyst bed reduces the “hot volume” residence time, which is important for preventing the formation of side-products. Avoiding pressure drop across the reactor vessel is important for meeting process requirements both within the radial flow reactor and in downstream process units.

Accordingly, it is desirable to provided processes and apparatus that balance the competing needs for good vapor distribution, while minimizing hot residence time and minimizing pressure drop inside the reactor. Furthermore, other desirable features and characteristics of the present disclosure will become apparent from the subsequent detailed description and the appended claims, taken in conjunction with the accompanying drawings and the foregoing technical field and background.

### BRIEF SUMMARY

A system for radial flow contact of a reactant stream with catalyst particles, the system includes a reactor vessel and a catalyst retainer disposed in the reactor vessel, the catalyst retainer including an inner particle retention device and an outer particle retention device, the inner particle retention device and the outer particle retention device being spaced apart to define a catalyst retaining space of the catalyst retainer, the inner particle retention device defining an axial flow path of the reactor vessel, the outer particle retention device and an inner surface of a wall of the reactor vessel defining an annular flow path of the reactor vessel. The system further includes an inlet nozzle positioned along a side of the reactor vessel and having an exit opening in fluid communication with the annular flow path of the reactor vessel and an outlet nozzle in fluid communication with the axial flow path of the reactor vessel.

### BRIEF DESCRIPTION OF THE DRAWINGS

The present disclosure will hereinafter be described in conjunction with the following drawing figures, wherein like numerals denote like elements, and wherein:

FIG. 1 is a cross-sectional view of an exemplary side-inlet radial flow reactor; and

FIG. 2 is a top cross-sectional view of the exemplary side-inlet radial flow reactor illustrated in FIG. 1.

### DETAILED DESCRIPTION

The following detailed description is merely illustrative in nature and is not intended to limit the embodiments of the subject matter or the application and uses of such embodiments. Furthermore, there is no intention to be bound by any expressed or implied theory presented in the preceding technical field, background, brief summary or the following detailed description.

In an example, the hydrocarbon conversion process is a reforming process. The reforming process is a common process in the refining of petroleum, and is usually used for increasing the amount of gasoline. The reforming process includes mixing a stream of hydrogen and a hydrocarbon mixture and contacting the resulting stream with a reforming catalyst. The usual feedstock is a naphtha feedstock and generally has an initial boiling point of about 80° C. and an end boiling point of about 205° C. The reforming reactors are operated with a feed inlet temperature from about 450° C. to about 540° C. The reforming reaction converts paraffins and naphthenes through dehydrogenation and cyclization to aromatic compounds. The dehydrogenation of paraffins can yield olefins, and the dehydrocyclization of paraffins and olefins may yield aromatic compounds.

Reforming catalysts generally include a metal on a support. The support can include a porous material, such as an inorganic oxide or a molecular sieve, and a binder with a weight ratio from about 1:99 to about 99:1. The weight ratio is preferably from about 1:9 to about 9:1. Inorganic oxides used for support include, but are not limited to, alumina, magnesia, titania, zirconia, chromia, zinc oxide, thoria, boria, ceramic, porcelain, bauxite, silica, silica-alumina, silicon carbide, clays, crystalline zeolitic aluminasilicates, and mixtures thereof Porous materials and binders are known in the art and are not presented in detail here. The metals preferably are one or more Group VIII noble metals, and include platinum, iridium, rhodium, and palladium. Typically, the catalyst contains an amount of the metal from about 0.01% to about 2% by weight, based on the total weight of the catalyst. The catalyst may also include a promoter element from Group IIIA or Group IVA. These metals include gallium, germanium, indium, tin, thallium and lead.

The hydrocarbon conversion process may be a dehydrocyclodimerization process wherein the feed includes C2 to C6 (wherein the term Cn refers to a hydrocarbon having n carbon atoms) aliphatic hydrocarbons that are converted to aromatics. Exemplary feed components include C3 and C4 hydrocarbons such as isobutane, normal butane, isobutene, normal butene, propane and propylene. Diluents, for example nitrogen, helium, argon, and neon may also be included in the feed stream. Dehydrocyclodimerization operating conditions may include a reaction temperature from about 350° C. to about 650° C., a pressure from about 0 kPa(g) to about 2068 kPa(g), and a liquid hourly space velocity from about 0.2 to about 5 hr⁻¹. Exemplary process conditions include a reaction temperature from about 400° C. to about 600° C., a pressure from about 0 kPa(g) to about 1034 kPa(g), and a liquid hourly space velocity of from 0.5 to 3.0 hr⁻¹. It is understood that, as the average carbon number of the feed increases, a reaction temperature in the lower end of the reaction temperature range is required for optimum performance and conversely, as the average carbon number of the feed decreases, the higher the required reaction temperature. Details of the dehydrocyclodimerization process are found for example in U.S. Pat. No. 4,654,455 and U.S. Pat. No. 4,746,763.

The dehydrocyclodimerization catalyst may be a dual functional catalyst containing acidic and dehydrogenation components. The acidic function is usually provided by a zeolite which promotes the oligomerization and aromatization reactions, while a non-noble metal component promotes the dehydrogenation function. Exemplary zeolites include ZSM-5, ZSM-8, ZSM-11, ZSM-12, and ZSM-35. One specific example of a catalyst disclosed in U.S. Pat. No. 4,746,763 includes a ZSM-5 type zeolite, gallium, and a phosphorus containing alumina as a binder. Multiple reactors or reaction zones may be used to manage the heat of reaction. The dehydrocyclodimerization process regeneration zone pressure may be from about 0 kPa(g) to about 103 kPa(g). In a particular embodiment, the regeneration conditions may include a step that includes exposing the catalyst to liquid water or water vapor as detailed in U.S. Pat. No. 6,657,096.

In an example, the hydrocarbon conversion process is a dehydrogenation process for the production of olefins from a feed that includes a paraffin. The feed may include C2 to C30 paraffinic hydrocarbons and, in one exemplary embodiment, includes C2 to C5 paraffins. General dehydrogenation process conditions include a pressure from about 0 kPa(g) to about 3500 kPa(g), a reaction temperature from about 480° C. to about 760° C., a liquid hourly space velocity from about 1 to about 10 hr⁻¹. and a hydrogen/hydrocarbon mole ratio from about 0.1:1 to about 10:1. Dehydrogenation conditions for C4 to C5 paraffin feeds may include a pressure from about 0 kPa(g) to about 500 kPa(g), a reaction temperature from about 540° C. to about 705° C. a hydrogen/hydrocarbon mole ratio from about 0.1:1 to about 2:1; and an liquid hourly space velocity of less than about 4 hr⁻¹. Additional details of dehydrogenation processes and catalyst may be found, for example, in U.S. Pat. No. 4,430,517 and U.S. Pat. No. 6,969,496.

Generally, the dehydrogenation catalyst includes a platinum group component, an optional alkali metal component, and a porous inorganic carrier material. The catalyst may also contain promoter metals and a halogen component which improve the performance of the catalyst. In an embodiment, the porous carrier material is a refractory inorganic oxide. The porous carrier material may be an alumina with theta alumina being a preferred material. The platinum group includes palladium, rhodium, ruthenium, osmium, and iridium and generally includes from about 0.01 wt % to about 2 wt % of the final catalyst. Potassium and lithium are exemplary alkali metal components including from about 0.1 wt % to about 5 wt % of the final catalyst. An exemplary promoter metal is tin in an amount such that the atomic ratio of tin to platinum is between about 1:1 and about 6:1. A more detailed description of the preparation of the carrier material and the addition of the platinum component and the tin component to the carrier material may be obtained by reference to U.S. Pat. No. 3,745,112. The dehydrogenation process regeneration zone pressure may be from about 0 kPa(g) to about 103 kPa(g).

Aspects of the present disclosure relate to particle retention devices for use in apparatuses for contacting fluids (e.g., gases, liquids, or mixed phase fluids containing both gas and liquid fractions) with solids that are typically in particulate form (e.g., spheres, pellets, granules, etc.). The maximum dimension (e.g., diameter of a sphere or length of a pellet), for an average particle of such particulate solids, is typically from about 0.5 mm (0.02 inches) to about 15 mm (0.59 inches), and often from about 1 mm (0.04 inches) to about 10 mm (0.39 inches). An exemplary solid particulate is a catalyst used to promote a desired hydrocarbon conversion reaction and normally containing a catalytically active metal or combination of metals dispersed on a solid, microporous carrier as described above. Catalysts and other solid particulates are retained in particle retention devices when the smallest widths of the flow channels, for passage of fluid in the radial direction, are less than the smallest dimension (e.g., diameter of a sphere or diameter of the base of a pellet), for an average particle of a particulate solid. Typical smallest or minimum flow channel widths (e.g., formed as gaps or openings between adjacent, spaced apart profile wires or windings of profile wires) are from about 0.3 mm (0.01 inches) to about 5 mm (0.20 inches), and often from about 0.5 mm (0.02 inches) to about 3 mm (0.12 inches). A representative apparatus containing a particle retention device according to the present disclosure is therefore a radial flow reactor that may be used in a number of chemical reactions including hydrocarbon conversion reactions such as catalytic dehydrogenation and catalytic reforming

Use of the term “particle retention device” is understood to refer to devices that retain, or restrict the flow of, a solid particulate in at least one direction (e.g., radially), but do not necessarily immobilize the solid particulate. In fact, contemplated applications of the particle retention devices include their use in radial flow reactors in which the solid particulate, often a catalyst used to promote a desired conversion, is in a moving bed that allows the catalyst to be intermittently or continuously withdrawn (e.g., for regeneration by burning accumulated coke) and replaced in order to maintain a desired level of catalytic activity in the reactor. Therefore, the particle retention device may, for example, confine the catalyst in the radial direction (e.g., from the center of the reactor to an outer radius of a cylindrical retention zone or otherwise between an inner radius and an outer radius of an annular retention zone) but still allow the catalyst to move axially in the downward direction.

Representative embodiments of the disclosure are directed to radial flow reactors, including moving bed reactors, including a vessel, a particle retention device, and a fluid displacement device, as described herein, that is disposed in the vessel to promote the desired fluid/solid particulate contacting. In many cases, the vessel, particle retention device, and fluid displacement device, will have a circular cross-section, with the vessel, particle retention device, and fluid displacement device being positioned concentrically, and often with their common axes extending vertically. Other vessel geometries for the vessel and/or particle retention device and/or fluid displacement device, for example conical, or cylindrical with one or more conical ends, are possible. The fluid displacement devices may also be used in reactors having cross-sectional shapes that are not circular, for example elliptical or polygonal. Normally, the cross-sectional shapes of the vessel, particle retention device and fluid displacement device will be the same (although varied in size) at any common axial position within the vessel, in order to promote radial flow uniformity.

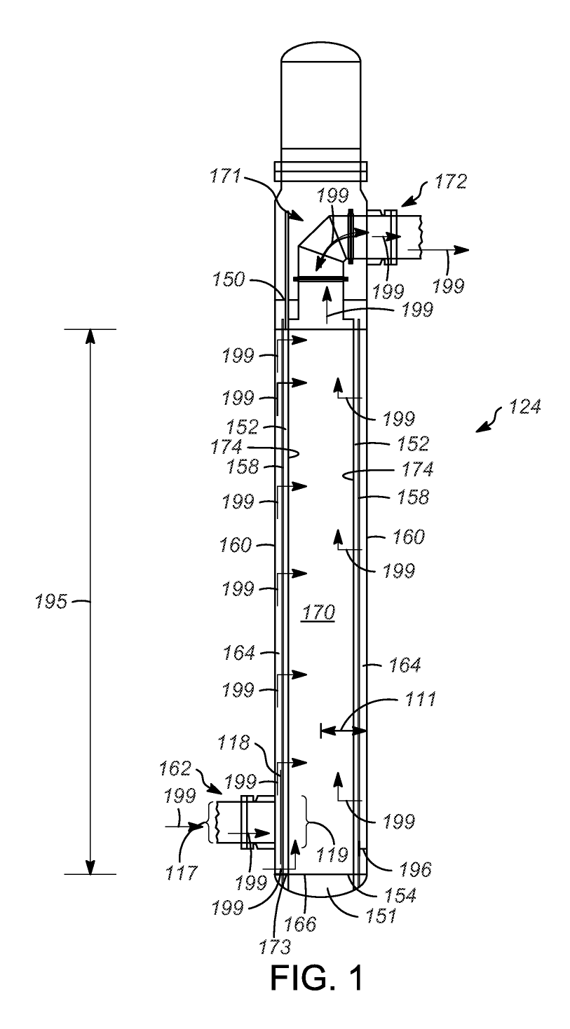

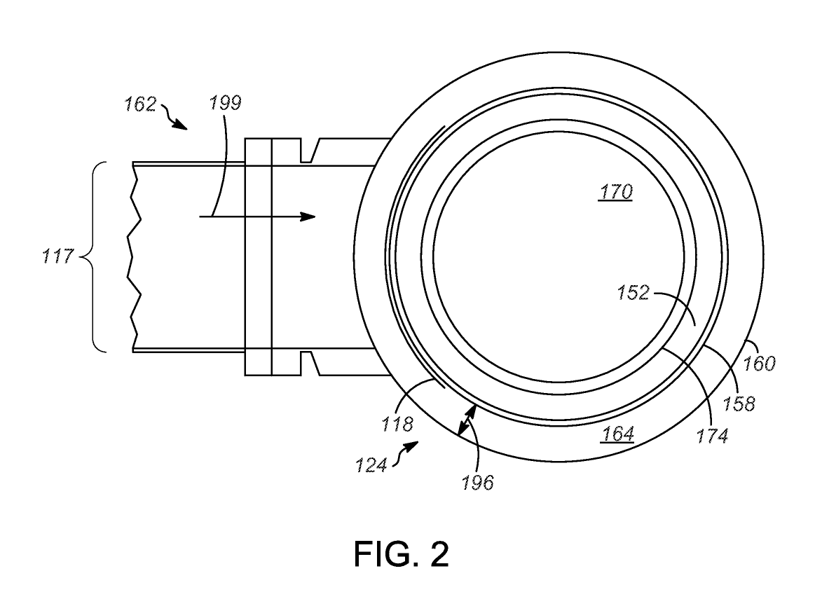

Referring now to the Figures, FIG. 1 shows a side cross-sectional view of an exemplary side-inlet inward radial flow reactor vessel 124 in accordance with one embodiment of the present disclosure, and FIG. 2 shows a top cross-sectional view thereof Catalyst particles (not shown) are transferred by a series of transfer conduits 150 into a particle retaining space 152 in the interior space of the vessel 124. A bed of catalyst particles is formed in retaining space 152 immediately below the lower extent of transfer conduits 150. A vessel partition 154 defines a catalyst collection space 151 below the lower extent of retaining space 152 and the catalyst bed. An inner particle retention device 174 and an outer particle retention device 158 define the extent of the catalyst bed in retaining space 152, which has a generally annular cross section. Catalyst particles are withdrawn from the bottom of retaining space 152 into the catalyst collection space 151 and then through another series of transfer conduits (not shown) that transfer the catalyst particles from the reactor vessel 124.

The reactant stream enters the vessel 124 through a side inlet nozzle 162 and flows into an outer chamber 164 defined by an interior surface of the outer wall 160 of the vessel 124 and an exterior surface of the outer particle retention device 158. The side inlet nozzle 162 located between the bottom and top of the catalyst bed (thus being referred to as a “side” nozzle, as opposed to prior art “top” nozzles, which are positioned above the catalyst bed), which as noted above, is located between transfer conduits 150 and collection space 151 within the retaining space 152, the height of which being shown in FIG. 1 by reference numeral 195. This positioning of the inlet nozzle 162 desirably minimizes the hot residence time/volume, as initially noted above. In this manner, the nozzle is located at the same elevation as the catalyst bed, which reduces the hot volume/residence time. In one exemplary embodiment, as shown in the Figures, the inlet nozzle 162 may be located near the bottom of the catalyst bed (i.e., that portion nearest to collection space 151), for example in the lower 50%, the lower 30%, or the lower 10% of the bed height 195.

In some embodiments, there may be more than one inlet nozzle 162. For example, there may be two, three, or more inlet nozzles. In a configuration of two, three, etc., inlet nozzles, each such nozzle may be coplanar with respect to their elevation on the reactor vessel 124. For example, with three inlet nozzles, all at the same elevation as the single inlet nozzle 162 shown in FIG. 1, they may be separated by about 120 degrees around the reactor vessel 124 (in the case of equidistant spacing around the vessel 124). In an alternate configuration of two, three, etc., inlet nozzles, each such nozzle may be stacked on top of the other, such that each inlet nozzle is at a different elevation along the reactor vessel 124. Some combination of stacked and coplanar positioning may also be employed in the case of three or more inlet nozzles.

Returning to FIGS. 1 and 2, a base plate 166 extends across the bottom of chamber 164 to separate it from the catalyst collection space 151. Chamber 164 communicates the reactants with the interior of the retaining space 152 through the outer particle retention device 158. In an exemplary embodiment, the radial distance between the interior surface of the outer wall 160 of the vessel 124 and the exterior surface of the outer particle retention device 158 (shown in the Figures as distance 196) is minimized to further minimized the to minimize hot residence time/volume. For example, the distance 196 may be less than 20%, less than 15%, or less than 10% of the total radius 111 of reactor vessel 124.

Positioned adjacent to the exterior surface of the outer particle retention device 158 is a distribution baffle 118 that serves to distribute the reactant flow upon their entry into reactor vessel 124. The distribution baffle 118 has a height 119 that is at least as great as the diameter 117 of the inlet nozzle 162. In an exemplary embodiment, the height 119 of distribution baffle 118 is greater than 110%, greater than 130%, or greater than 150% of the diameter 117 of the inlet nozzle 162. The distribution baffle 118 may extend any distance circumferentially around the outer particle retention device 158, for example, greater than 10% of the circumference, greater than 30% of the circumference, or greater than 50% of the circumference of the outer particle retention device. The distribution baffle 118 may be provided in any type known in the art, for example in the solid or perforated types, as may be desirable for fluid distribution and/or minimizing pressure drop.

After distribution by the baffle 118, the reactants pass across retaining space 152, through the inner particle retention device 174, and are collected by a central conduit 170 defined by the interior space of the inner particle retention device 174. Central conduit 170 has a closed bottom and transports the effluent vapors from retaining space 152 upward and out of the vessel 124 through an outlet nozzle 172 via elbow connector 171. The inlet nozzle 162 and outlet nozzle 172 may be at different elevations. For example, the outlet nozzle 172 may be either above or below the inlet nozzle 162. In one embodiment, the outlet nozzle 172 may be placed near the top of reactor vessel 124 (as shown in FIG. 1) for use with an integral-type catalyst collector. In another (non-illustrated) embodiment, the outlet nozzle 172 may be located near the bottom of reactor vessel 124 for use with an external-type catalyst collector. However, it will be appreciated that a configuration, such as in FIG. 1, wherein the outlet nozzle 172 is at a higher elevation than the inlet nozzle 162, may also be employed with the external-type catalyst collector.

Means are provided for supporting the particle retention devices 158 and 174 in place within the vessel 124. Based on the configuration illustrated, the particle retention devices 158 and 174 are supported from the bottom. For example, in FIG. 1, a support 173 positioned near the bottom of the reactor vessel 124 contacts the lower end of the outer particle retention device 158 in order to hold the outer particle retention device 158 in place.

Flow arrows 199 in the Figures illustrate radial fluid flow through inner and outer particle retention devices 174, 158, and also through catalyst particle retaining space 152, but an overall upward flow of feed distributed to, and product collected from, the particle retaining space 152.

The outer particle retention device 158 has a controlled pressure drop/vapor distribution effect. The outer particle retention device 158 can be designed with a pressure drop of between about 350 Pa (0.05 psi) to about 35,000 Pa (5.0 psi) greater than the axial friction loss in the conduit 170 pressure drop in an example. The pressure drop may be greater than the axial friction loss in the conduit 170 pressure drop of from about 350 Pa (0.05 psi) to about 20,500 Pa (3.0 psi) in another example, from about 7000 Pa (1.0 psi) to about 35,000 Pa (5.0 psi) in another example, from about 7000 Pa (1.0 psi) to about 20,500 Pa (3.0 psi) in another example, from about 350 Pa (0.05 psi) to about 7000 Pa (1.0 psi) in another example, and from about 350 Pa (0.05 psi) to about 3500 Pa (0.50 psi) in yet another example.

While use of the radial flow apparatus is not limited to any process, the radial flow apparatus can be particularly beneficial in: (i) the catalytic reforming of a hydrocarbon feedstream (e.g., a naphtha feedstream) to produce aromatics (e.g., benzene, toluene and xylenes) (see, e.g., U.S. Patent Application Publication Nos. 2012/0277501, 2012/0277502, 2012/0277503, 2012/0277504, and 2012/0277505); (ii) high temperature reforming (see U.S. Patent Application Publication No. 2012/0275974); (iii) the conversion of liquid petroleum gas (LPG) into liquid aromatics (e.g., the UOP Cyclar™ process); and (iv) the catalytic dehydrogenation of a paraffin stream to yield olefins (see, e.g., U.S. Pat. No. 8,282,887).

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

1. A system for radial flow contact of a reactant stream with catalyst particles, the system comprising:
a reactor vessel;
a catalyst retainer disposed in the reactor vessel, the catalyst retainer including an inner particle retention device and an outer particle retention device, the inner particle retention device and the outer particle retention device being spaced apart to define a catalyst retaining space of the catalyst retainer, the inner particle retention device defining an axial flow path of the reactor vessel, the outer particle retention device and an inner surface of a wall of the reactor vessel defining an annular flow path of the reactor vessel;
a side inlet nozzle positioned along a side of the reactor vessel and having an exit opening in fluid communication with the annular flow path of the reactor vessel; and
an outlet nozzle in fluid communication with the axial flow path of the reactor vessel.

2. The system of claim 1, further comprising a fluid distribution baffle disposed in the axial flow path of the reactor vessel.

3. The system of claim 2, wherein the fluid distribution baffle extends annularly and adjacent to the outer particle retention device.

4. The system of claim 2, wherein the fluid distribution baffle has a height along the reactor vessel that is at least 100% of a diameter of the inlet nozzle.

5. The system of claim 4, wherein the fluid distribution baffle has either a solid or a perforated configuration.

6. The system of claim 1, wherein the outer particle retention device is supported from a lower end of the outer particle retention device.

7. The system of claim 1, wherein the inlet nozzle is in fluid communication with a source of the reactant stream.

8. The system of claim 1, wherein a single inlet nozzle is in fluid communication with the annular flow path of the reactor vessel.

9. The system of claim 1, wherein the inlet nozzle is at a lower elevation than the outlet nozzle.

10. The system of claim 1, wherein the outlet nozzle is positioned above the catalyst retaining space.

11. The system of claim 1, further comprising an integral catalyst collector.

12. The system of claim 1, further comprising two or three inlet nozzles.

13. The system of claim 12, wherein the two or three inlet nozzles are in a coplanar configuration or a stacked configuration.

14. A system for radial flow contact of a reactant stream with catalyst particles, the system comprising:
a reactor vessel;
a catalyst retainer disposed in the reactor vessel, the catalyst retainer including an inner particle retention device and an outer particle retention device, the inner particle retention device and the outer particle retention device being spaced apart to define a catalyst retaining space of the catalyst retainer, the inner particle retention device defining an axial flow path of the reactor vessel, the outer particle retention device and an inner surface of a wall of the reactor vessel defining an annular flow path of the reactor vessel; and
a side inlet nozzle that has an elevation with respect to the reactor vessel that is within the catalyst retaining space.

15. The system of claim 14 wherein:
the system includes an inlet nozzle having an exit opening in fluid communication with the annular flow path of the reactor vessel

16. The system of claim 14, further comprising a fluid displacement baffle.

17. The system of claim 14, wherein the outer particle retention device is supported from lower end of the outer particle retention device.

18. The system of claim 14, wherein the inlet nozzle is in fluid communication with a source of the reactant stream.

19. The system of claim 14, wherein the inlet nozzle is at a lower elevation than the outlet nozzle.

20. A process for contacting of a reactant stream with catalyst particles, the process comprising:
(a) providing a reactor vessel and a catalyst retainer disposed in the reactor vessel, the catalyst retainer including a inner particle retention device and an outer particle retention device, the inner particle retention device and the outer particle retention device being spaced apart to define a catalyst retaining space of the catalyst retainer, the inner particle retention device defining an axial flow path of the reactor vessel, the outer particle retention device and an inner surface of a wall of the reactor vessel defining an annular flow path of the reactor vessel; and
(b) feeding a reactant stream into the axial flow path of the reactor vessel at a side elevation with respect to the particle retention device that is within the particle retention device.
